(19) United States
(12) Patent Application Publication
(10) Pub. No.: US 2002/0099910 A1
(43) Pub. Date: Jul. 25, 2002

(54) High speed low power cacheless computer system

(76) Inventor: Emanuel E. Shah, Austin, TX (US)

Correspondence Address: EMANUEL E. SHAH, 11606B ARGONNE FOREST TRAIL, AUSTIN, TX, 78759, US

(21) Appl. No.: 10/047,234

(22) Filed: Jan. 14, 2002

Related U.S. Application Data
(60) Provisional application No. 60/263,436, filed on Jan. 23, 2001.

(51) Int. Cl. G06F 13/00

(52) U.S. Cl. 711/117; 711/154

(57) ABSTRACT

A cacheless computer system comprising a central processing unit (CPU) and a high speed transition buffer interacting with different computer system resources such as address controller, main semiconductor memory and input output devices by means of plurality of system buses. The transition buffer contains starting memory locations of each jump or branch location of the program. When a branch or jump instruction is encountered by the CPU, it fetches the starting locations from the high speed transition buffer executing at CPU speed. When multiple instructions are executed from the transition buffer, enough time is available to the address controller to access the remainder of the branch or jump program located on the slower, low power, low cost DRAM type memory. The program then continues to be executed from the parallel blocks of memory pre-fetched and available on parallel memory blocks without access time requirements until the program is completed or a next jump or branch instruction is encountered. The size of the program that can be executed without interruption can be the size of the entire main semiconductor memory. The system also works on multiprocessing system where cache coherency problems are eliminated. Time critical real time applications are more deterministic, Digital signal processors (DSP) for real time applications are able to implement larger programs without cache miss and latency problems. A new compiler is required to compile the program for the unique requirements of this architecture. Timing characteristics of the implementation is understood well in advance at the compile time.

This application claims the benefit of Provisional patent application serial No. 60/263,436 filed Jan. 23, 2001.

### FIELD OF THE INVENTION

The present invention relates to high speed, low power computer systems. Both for larger super computers as well as smaller desk top PCs. This specifically refers to computer systems which operates without the use of cache memories for proper operation.

### BACKGROUND OF THE INVENTION

The operating speed of the CPU in a computer system is always faster than the access time of the memory it uses. This creates the problem of CPU operating speed limited by the speed at which the memory is available to the CPU for execution. A cache having higher access time then the main memory is used to partially overcome this disparity in speed. The memory cache holds a definite part of the program resident in the main memory and executes at a higher speed. This still has many disadvantages. If the program jump or a routine is located outside the cache memory, a miss occurs and a long time to refill the cache is required. This slows down the speed at which a CPU can operate. Also, in order to avoid miss to occur, the range to the jump or a routine is always limited to the size permitted by the cache. The size of the program segment the CPU can handle is also limited by the size of the cache.

The present inventor has successfully developed a new and unique concept by which a new cacheless computer system can be designed with superior performance and without the disadvantages of the cache based computer system. Because of the unique concept used in the design of the cacheless computer system it is possible to run the CPU at any desired speed without any kind of interruption of execution of the program. Another advantage is that the CPU speed is not affected by the access time of the memory. One of the primary advantages offered by this invention is that unlike the cache based systems, where the program segment is limited by the size of the cache, the inventor has developed a new concept where CPU can execute a much larger size of the program equal to the total size of the main execution memory. This feature allows servers to be much faster, efficient and energy efficient. A low cost slower memory using less power can be efficiently used to work with a fastest CPU without any speed and cost penalty. It is also possible to incorporate a built in power management system which does not require complex external hardware. This evolves to a computer system, which is more cost effective and environmentally friendly and efficient.

The computer system based on the present invention can be implemented in a standard architecture where data and instruction are processed in the same memory area. It can also be efficiently designed with Harvard type architecture. The data and instruction memory can be resident on different memory areas. The transition buffer will be divided in data transition buffer and instruction transition buffer.

The architecture based on the present invention also allows use of prior art techniques such as branch prediction logic.

The present invention also offers zero latency interrupt response feature.

Another problem encountered with the cache memories is maintaining cache coherency and consistency. Multiple copies of same data can exist in cache and main execution memory of the computer system. The two copies may not have same values leading to program execution errors. This can occur in both, uniprocessor or multiprocessor environments.

Multiprocessor systems use cache on individual processors to execute a larger program. The inconsistencies in the value of the same data in different cache memories cause serious problems in program execution because the most recent value of the data is not easily determined and available. The problem becomes so serious in some applications, alternate protocols such as shared memories and message passing is used. This deteriorates the performance of the multiprocessing computing systems. The present system eliminates the cache coherency problems in multiprocessing systems and system performance is maintained at maximum possible levels.

High speed DMA is used to transfer program from mass storage devices like hard drives to the DRAM. Other 10 operations are performed by 10 devices to provide other data transfers. The process is performed at a much slower speed than the CPU or 10 processor is capable of performing. A quick response, high throughput 10 system will be desirable.

Another major problem with the prior art cache based system is that it is difficult to accurately estimate time of execution and potential conflicts between data values being updated by different devices at the compile time. Many of the problems with timing conflicts can be determined at the compile time. For uniprocessor and multiprocessor systems precaution can be taken at the compile time to determine the timing of writing of data to a specific location by more than one device such as CPU and an input/output device and in multiprocessor systems care will be taken to assure that different processors will write data to the same location. This information can then be used to assure that proper sequence of machine language code is used to avoid any conflict between different devices.

Digital signal processors (DSP) are mainly intended for time critical real time applications. The function and operation of cache in DSP is not acceptable in the prior art because the cache does not allow deterministic operation required by the DSP's. An article in “IEEE Spectrum” June 2001 pages 62-68, describes the problem in more detail. The present invention opens the application of DSP's to much larger programs and at a much higher performance levels than possible before.

A technique currently employed to overcome the slower speed of the memory is to use the memory cells in parallel. This is done by connecting memory banks in parallel such as used in a burst mode of transfer of data. The disadvantage of this technique to increase the speed of the memory is that it can access memory only in sequential mode. A jump or branch to a routine is not possible. Most computer programs have numerous jumps and branches without which normal program execution is not possible.

In view of the foregoing, it would be highly desirable to have a uniprocessor and multiprocessor computing system with high memory bandwidth to match CPU speed, have solution to cache coherency and consistency problems and have an interrupt system with low latency response. It would also be desirable to have system that will manage power consumption. In addition it would be of great value to have a compiler and an assembler that can predict and correct performance problems at compile time. Deterministic operation of any computing system has been a difficult goal to achieve even with many enhancements and additional hardware and software enhancements. A solution to obtain deterministic operation will be desirable both in terms of cost and new areas of applications. The present invention achieves all of the above goals and objectives in a cost effective and efficient manner.

### SUMMARY OF THE INVENTION

The multiple objectives of a uniprocessor and multiprocessor computing systems offering deterministic performance with high memory bandwidth to match CPU speed, solution to cache coherency and consistency problems and an interrupt system with low latency response, system that will manage power consumption is successfully achieved by a new and inventive architectural and circuit design concepts. In addition, a compiler and an assembler is proposed that can predict and correct performance problems at compile time, further making deterministic and high performance operation possible.

The present invention achieves high speed low power operation by using low power dynamic RAM in a unique parallel operation allowing high speed access with slower low power dynamic RAM. There is built in power management where only the currently active circuit is “on” and supplied with full power while rest of the hardware is in “off” or quiescent state. The main problem with the prior art systems is effectively handling jump or branch instructions without delay or program interruption.

The present invention handles a jump or branch in a very inventive and unique manner. When a jump or branch instruction is encountered, the starting locations of the new jump or branch is executed from a high speed static RAM called the transition buffer. This is done by Central processing unit (CPU) by selecting the address of the memory location on the transition buffer. The program counter on the CPU is loaded with the address of the locations from the transition buffer. While the CPU is executing starting locations of the new jump or branch from the transition buffer the main execution memory of the computer is being accessed by the address controller of the computer system. The address controller communicates with transition buffer through a logic in the address controller which relates each group of starting locations on the transition buffer with a group of memory locations on the main execution memory where the remainder of the program is located. The address controller begins access to the main execution memory at the same time the CPU starts executing the first memory location of the new branch program locations on the transition buffer. The slower main execution memory takes multiple CPU cycles to complete the access. The number of starting locations on the transition buffer is generally equal to the multiple CPU cycles needed to access main execution memory.

The CPU then completes the execution of the starting locations for the given jump or branch locations on the transition buffer. While the CPU is executing the starting locations for the given jump or branch locations on the transition buffer, the address controller completes the access to the main execution memory containing the remainder of the program locations for that particular jump or branch locations. The slower main execution memory provides enough time to address controller to complete the access to desired locations on the main execution memory. This is accomplished in sufficient time while the CPU is executing multiple starting locations from the faster transition buffer without speed or program interruption penalty imposed on the execution of the program.

The CPU then starts executing program locations from the main execution memory. This is implemented at the cycle time of the CPU since the main execution memory locations are now available for execution by the address controller. This continues until either the program has been completed or a new branch or jump instruction has been encountered.

The use of cache in DSP applications has not been acceptable before because the execution time depends upon the right data and instruction being present on the high speed cache memory. Because of this the cache does not allow deterministic operation required by the most DSP applications. The use of Harvard architecture with separate data and instruction areas to store starting locations of program and data on transition buffer allows deterministic operation. The time of execution is more predictable at the compile time. This invention eliminates the problem of cache miss by eliminating need for cache memory to increase the speed of the DSP. This will allow any or the entire program to execute with the help of transition buffer from the main execution memory without the need for cache memory and attendant miss problems.

For uniprocessor systems any given data is allowed to have only one location. This will eliminate the need for multiple value of the same data creating the problems regarding the validity of data at any given time. Precaution can be taken at the compile time to determine the timing of writing of data to a specific location by more than one device such as CPU and an input/output device. This information can then be used to assure that proper sequence of machine language code is used to avoid any conflict between different devices.

In multiprocessing computing systems, in line with the architectural requirements of the present invention, a data is generally allowed to have only one location any where in the computing environment. This eliminates the problem of cache coherency and multiple value of the same data at different locations. Because of this, additional protocols such as shared memories and message passing is not required. This simplifies the architecture and improves performance.

High speed DMA is used to transfer program from mass storage devices like hard drives to the DRAM. Caches are often used to speed the process. However, this is not done at CPU speed. The transition buffer and main execution memory can be combined to speed the DMA process close to the CPU speed.

### BRIEF DESCRIPTION OF THE DRAWINGS

FIG. 1 shows architectural representation of the cacheless computer system

FIG. 2 shows architecture of main execution memory

FIG. 3 shows operation of a high speed memory bank

FIG. 4 shows connection scheme for high speed memory banks

FIG. 5 shows flexible connection scheme for the main execution memory

FIG. 6 shows address controller modes

FIG. 7 shows operation of transition buffer

FIG. 8 shows implementation of non pipelined architecture

FIG. 9 shows implementation of pipelined architecture

FIG. 10 shows interrupt logic

FIG. 11 shows implementation of Harvard architecture

FIG. 12 shows power management and control logic

FIG. 13 shows parallel operation with multi processors

### DETAILED DESCRIPTION OF THE INVENTION

The present inventor has invented a new concept by which jumps and branches can be executed without any speed or program interruption penalty imposed due to change of memory address. The computer system based on the concept of the present invention consists of four primary building blocks. A Central processing unit (CPU), main execution memory, transition buffer and an address controller.

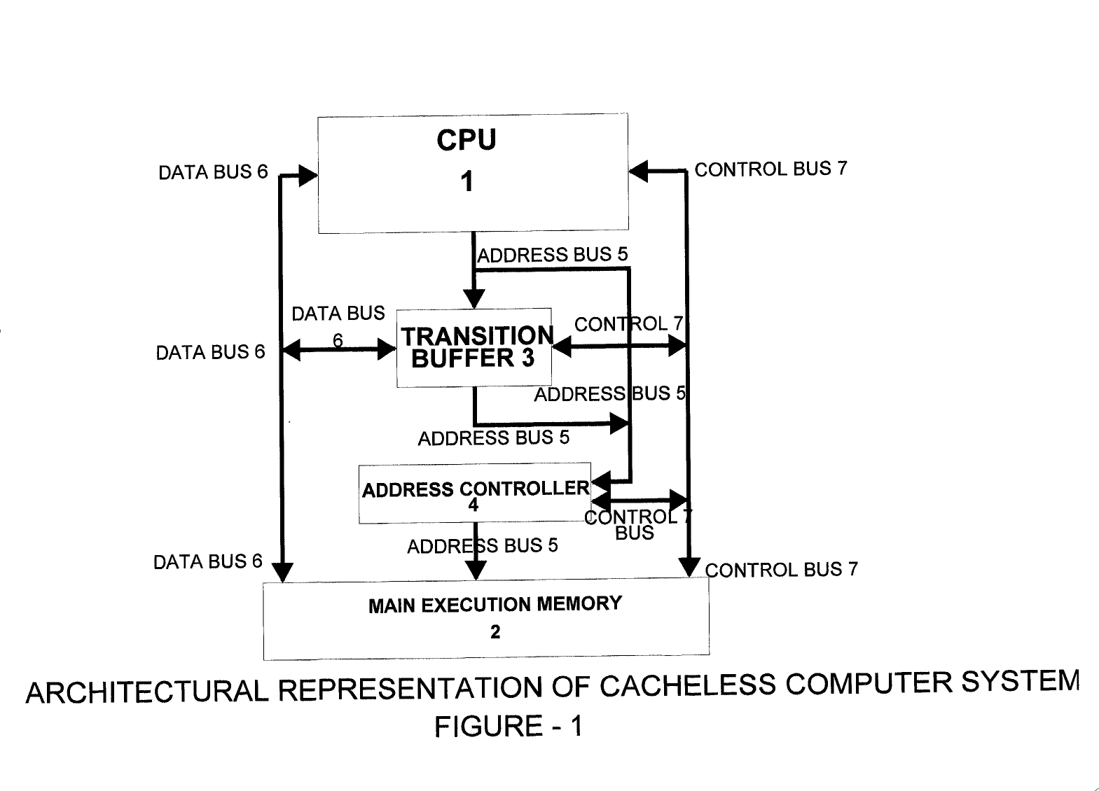

FIG. 1 shows the architectural representation of the computer system based on the present invention. It shows the main building blocks of the system and the architectural relationship between different building blocks. The CPU 1 performs the execution of program instructions in response to the contents of the memory it fetches from the desired memory storage.

The main execution memory 2 consists of the low cost, low power memory, which provides a bulk of storage for the program of the computer system. This memory is generally comprises of DRAM. The access time of the main execution memory is generally a fixed multiple of the CPU cycle time.

The next building block 3 is called the transition buffer. The transition buffer 3 is a high speed memory which has access time comparable to the cycle time of the CPU. The transition buffer 3 contains first starting memory locations for each jump and branch of the program. The number of locations for each jump or branch instruction stored in transition buffer 3 depends upon the ratio of access time of the main execution memory 2 to the access time of the transition buffer 3.

The final building block 4 is called the address controller. The function of the address controller 4 is to generate necessary address information and control signals, which will allow the CPU to fetch and execute instructions from either the transition buffer 3 or the main execution memory 2. It also performs other tasks such as finding the required routines for interrupt service and corresponding interrupt response mechanisms.

Address bus 5 provides the necessary address information to the various components of the computer system. Data bus 6 provides the path for the data needed and processed by the CPU 1. The data bus 6 can have multiple paths of data for different embodiments of the architecture. Control bus 7 provides path for different control signals needed for proper functioning of the different building blocks of the computer system.

After the CPU 1 starts executing instructions, it will continue to fetch and execute instructions from the selected storage component. When a jump or branch instruction is encountered by the CPU 1, the selected starting locations of the new jump or branch is executed from the transition buffer 3. This is done by CPU 1 by selecting the correct address of the memory location on the transition buffer 3 which corresponds to that jump or branch instruction. The program counter on the CPU 1 is then loaded with the address of the correct locations from the transition buffer 3. While the CPU 1 is executing starting locations of the new jump or branch from the transition buffer 3, the main execution memory 2 is being accessed by the address controller 4. The address controller 4 communicates with transition buffer 3 through a dedicated logic, in the address controller, which relates each group of starting locations on the transition buffer 3 with a group of memory locations on the main execution memory 2, where the remainder of the program is located. The address controller 4 begins access to the main execution memory 2 at the same time the CPU 1 starts executing the first memory location of the new branch program locations on the transition buffer 3. The slower main execution memory 2 takes multiple CPU 1 cycles to complete the access to the required memory locations. The number of starting locations on the transition buffer 3 is generally equal to the number of CPU 1 cycles needed to access main execution memory 2.

The address controller 4 begins access to the main execution memory 2 at the same time the CPUI begins execution of the starting locations for a given jump or branch program from the transition buffer 3. The CPU 1 then completes the execution of the starting locations for the given jump or branch locations on the transition buffer 3. While the CPU 1 is executing the starting locations for the given jump or branch locations on the transition buffer 3, the address controller 4 completes the access to the main execution memory 2 containing the remainder of the program locations for that particular jump or branch locations. The slower main execution memory 2 provides enough time to address controller 4 to complete the access to desired locations on the main execution memory 2. This is accomplished in sufficient time while concurrently, the CPU 1 is executing multiple starting locations from the faster transition buffer 3 without speed or program interruption penalty imposed on the execution of the program.

The CPU 1 then starts executing program locations from the main execution memory 2. This is implemented at the cycle time of the CPU 1 since the main execution memory locations are now made available for execution by the address controller 4. This continues until either the program has been completed or a new branch or jump instruction has been encountered by the CPU 1.

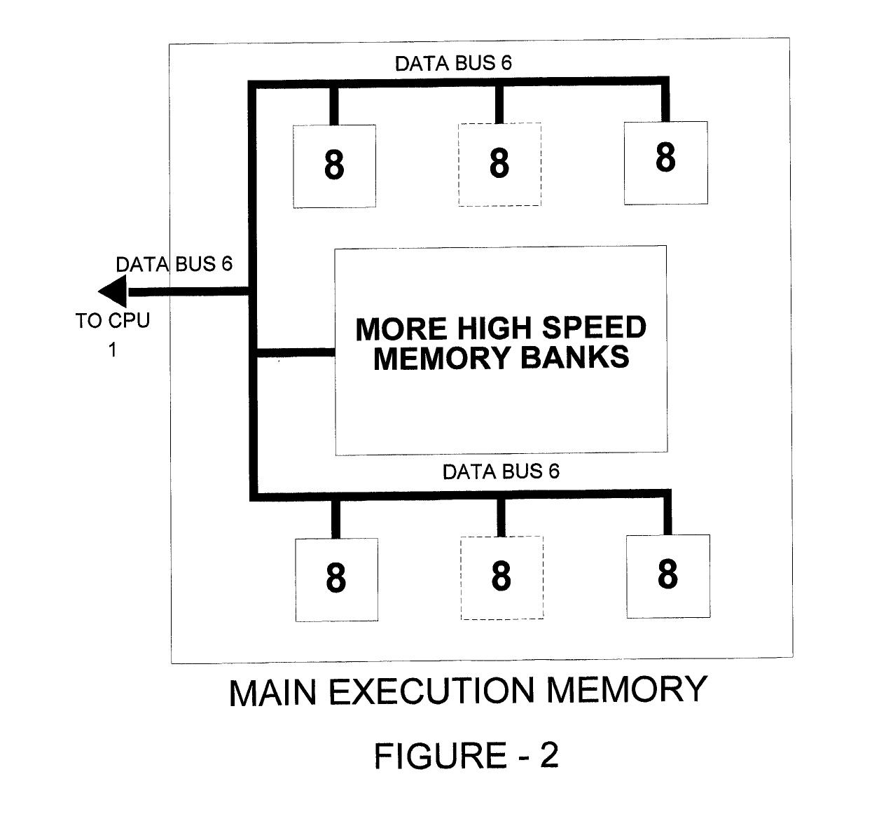

FIG. 2 shows main execution memory 2 and its component parts. The main execution memory 2, comprises a plurality of high speed memory banks 8. FIG. 2 further shows the detailed illustration of connection scheme of the high speed memory banks 8. The data bus 6 further connects the high speed memory banks 8 to the CPU 1.

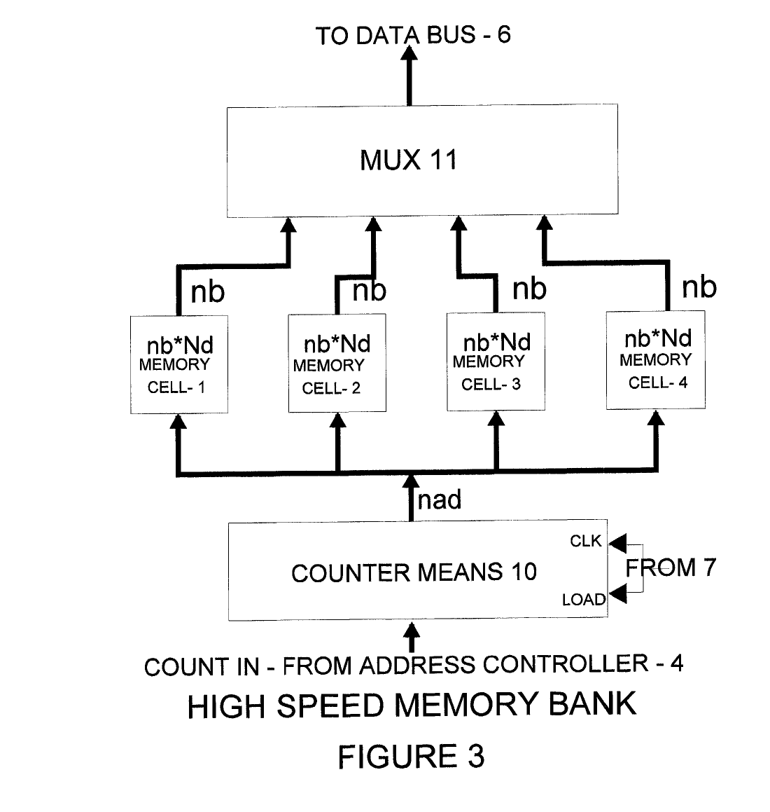

FIG. 3 shows a high speed memory bank 8. The high speed memory bank 8 further consists of multiple memory cells 9 connected in parallel. The example shows four memory cells 9 connected in parallel in order to illustrate the principle of the present invention. The memory cell 9 has each location with number of bits, “nb” and predefined number of memory locations “Nd”. A counter means 10 increments the address of the high speed memory bank at required frequency. The counter means 10 also presets the high speed memory bank 8 to a selected memory location. The counter means 10 has number of output bits “nad” to step through memory locations equal to Nd for each memory cell 9. When the address of high speed memory bank 8 is incremented, the address of each memory cell 9 in the high speed memory bank 8 is incremented simultaneously. The program instructions are loaded in the high speed memory bank 8 in series in such a manner that two subsequent program location to be executed by the CPU 1 is located on separate memory cell 9.

The output of the high speed memory bank 8 is controlled by a memory mux 11. The memory mux 11 selects each memory cell 9 and a program location on that cell is provided to the CPU 1 on the data bus 6 as required. Starting from the first cell, a program location resident on the high speed memory bank 8, is selected by the memory mux 11. The selected program data on that location is placed on the selected data bus 6 for the CPU 1 to access. After each CPU 1 cycle, the memory mux 11 selects the program location on the next memory cell 9. The memory cells are selected in series until the program location on the last memory cell is placed on the selected data bus 6 for the CPU 1 to access. It should be noted that the memory cells 1 to 4 on the high speed memory bank 8 are already accessed in advance by address controller 4 and CPU 1. Therefore, the memory mux 11 operating at the CPU cycle time allows the CPU 1 to access and execute the program on the high speed memory bank 8 at the CPU 1 cycle time. After all the memory locations in all the memory cells in a given high speed memory bank 8 at a selected address has been executed, the memory bank 8 is incremented by one address count by the counter means 10. When the address of the entire high speed memory bank 8 with all the memory cells 9 is incremented by one count, the address of the memory location on the last memory cell location to be accessed by the CPU 1 is incremented by the number equal to the number of memory cells 9 connected in parallel in given high speed memory bank 8.

An important features of the present invention is a flexible and reconfigurable architecture of the main execution memory 2. This feature according to the present invention gives main execution memory 2, for data and instruction to allow the high speed memory banks 8 to be connected in a series and or parallel connection as needed. A flexible connection scheme will allow the main execution memory 2 for data and instruction memory to be connected in a desired configuration which will allow individual memory elements of the main execution memory 2 to be accessed randomly by CPU 1 if desired. The random access capability gives the CPU 1 advantages in terms of accessing data and instructions not easily available on the transition buffer 3. This will also allow various data pipe lines on the main execution memory 2 within easy and fast access by the CPU 1.

One of the objectives of the present invention is to permit the use low cost, low power, slower memory to operate with CPU 1 at high speed without speed or program interruption penalty. This provides valuable cost, performance and environmental benefits. The high speed memory banks 8 used in the present invention is used as an important subsystem of the main execution memory system. Multiple number of high speed memory banks 8 are connected in parallel to achieve high speed memory access by the CPU 1.

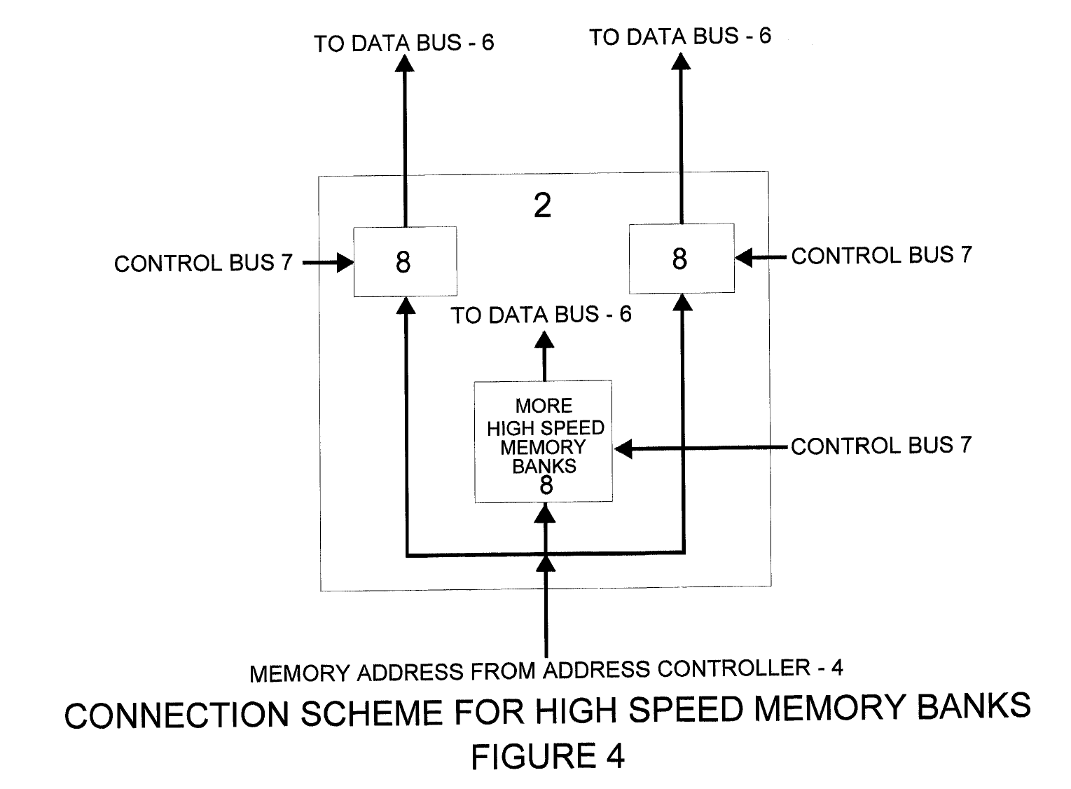

FIG. 4 shows plurality of high speed memory banks 8 connected in parallel. It should be noted that in any high speed memory bank 8, as shown in FIG. 3, two consecutive program location are located on separate memory cell in the same high speed memory bank. In a similar manner, when plurality of high speed memory banks 8 are connected in parallel, two groups of consecutive memory locations must be located on separate high speed memory banks 8. This is necessary for a slow memory to work with high speed CPU 1 operating at CPU 1 cycle time. It is necessary that enough time is available to the slower memory to access required memory locations on the memory cell 9 and place the required number of program locations for the memory mux 11 to access at CPU 1 cycle time. When sufficient number of program locations are available for the memory mux 11 to feed to the CPU 1 operating at the CPU time, the CPU 1 executes these program locations at CPU 1 cycle time. This gives enough time to the next high speed memory bank 8 to access the memory cells 9 and the next sequential program locations on memory cells 9 in advance. This is necessary for the next group of memory locations to be executed at CPU 1 cycle time.

This is achieved by connecting sufficient number of high speed memory banks 8 in parallel to provide enough time for the memory system to output program data in advance for the memory mux 11 to access at CPU 1 cycle time. The control logic and the CPU 1 selects alternate high speed memory banks 8 in main execution memory 2 by sending necessary control signals on the control bus 7. By selecting alternate high speed memory banks 8, where sequential program locations are resident, continuous execution of the program is maintained.

It is also important to remember that the address controller 4 can move forward or backward in a given high speed memory banks 8 as well as a group of high speed memory banks 8 connected in parallel. A high speed memory bank 8 can have large number of memory locations, such as 256 locations connected in parallel. This will allow the address controller to move forward and backwards within that high speed memory bank 8, permitting the CPU 1 to execute forward or backward branch in a given high speed memory bank 8. This is possible because all the memory locations are available to address controller 4 and CPU 1 within a high speed memory bank 8 for execution without additional memory access to a different address requiring longer access time.

This arrangement will allow CPU 1 to execute of forward or backward branch equal to the number of memory locations connected in parallel in a given high speed memory banks 8. This facilitates execution of instructions such as “if-then” branch, “while” loop or “for” loop without access to the transition buffer or other branch address pipelining schemes described later.

For the CPU 1 to operate at CPU 1 cycle time without unnecessary program interruption, at the initial start of the program, memory locations on the first high speed memory bank 8 are executed by the CPU 1 in sequential order. To effectively achieve this, at the initial start of the program, a selected number of high speed memory banks 8 are enabled and program data is placed on the output of the high speed memory banks for the memory mux 11 to access and transfer the selected data to the CPU 1 for execution. The selected data is accessed by the CPU in groups of consecutive program locations from the high speed memory banks 8.

When the first jump or branch instruction is encountered, the CPU 1 fetches and executes the starting locations of the next jump or branch path form the transition buffer 3 at CPU 1 cycle time. This will allow enough time for the high speed memory banks 8 connected in parallel to access the remainder of the program locations associated with the starting locations of the jump or branch path on the transition buffer 3. After enough time has elapsed in terms of number of CPU 1 cycles needed for the high speed memory banks 8 to access internal memory cells 9, the CPU 1 will execute the next step. This comprises fetching and executing instructions from the high speed memory banks 8. This will continue until the program is completed or next jump or branch instruction is encountered.

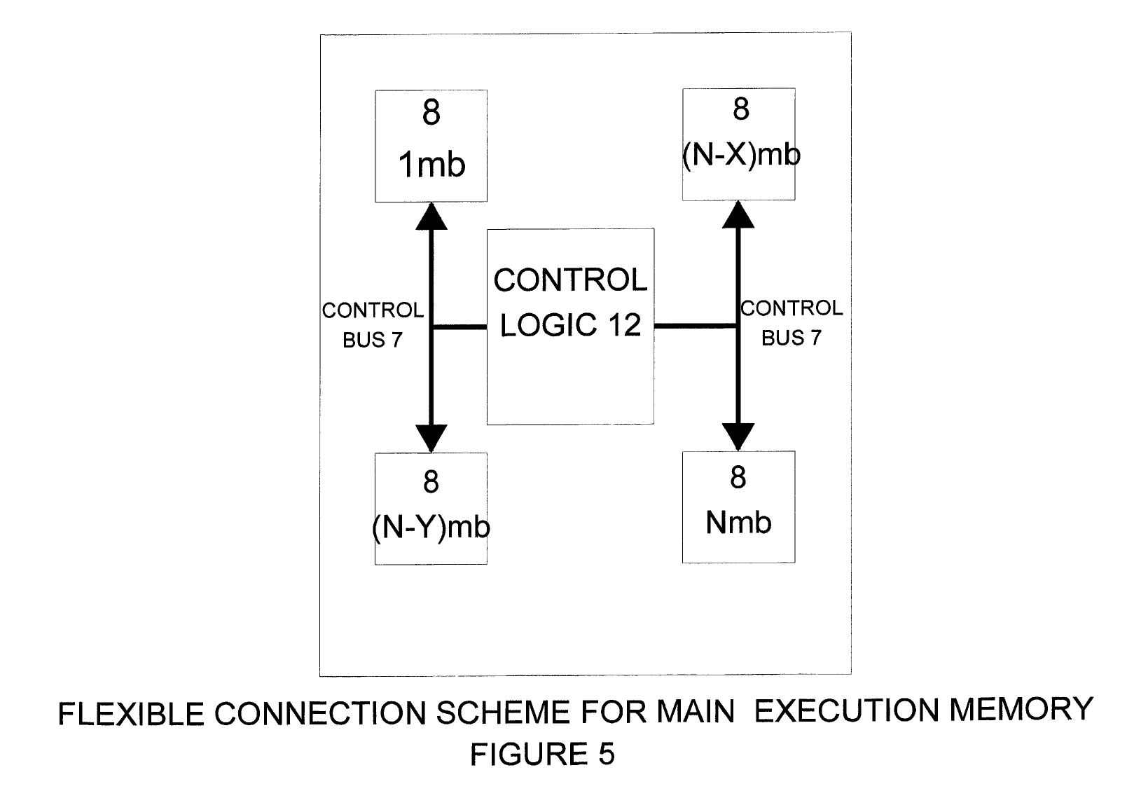

In specific program execution requirements, it is necessary to have a large number of memory locations be available to CPU 1 for access without any memory access delay. FIG. 5 shows the architecture that allows flexible connection of high speed memory banks 8 in main execution memory 2. The high speed memory banks 8 can be connected in parallel to have a large number of memory locations available in parallel for CPU 1 to fetch. In the next requirement, the number of memory locations required are sequential in nature. In this situation, the high speed memory banks 8 are connected in series. This ability of the main execution memory 2 to allow it's component sub-elements to be connected in series or parallel offers CPU 1 the ability to execute special branch instructions and other memory manipulation functions in sequence or in a random manner.

As shown in FIG. 5, the given main execution memory 2 has “Nmb” high speed memory bank elements. Control logic 12 will allow these elements to be connected in parallel or series. The control logic 12 can be suitably located either in main execution memory 2 or any other convenient location on the computer system. When all the Nmb elements are connected in parallel, the CPU will have access to all the starting locations of Nmb high speed memory banks 8 without any access delay. When a computed jump is required where jump location is not known in advance or conditional jump where the conditional jump has may conditional jump addresses, this type of parallel connection is very useful.

The parallel addresses can be manipulated by the control logic 12 to handle large number of possible memory locations which can be used by the CPU 1 to handle program branch instructions such as computed jump. By combining selected memory locations on the transition buffer 3 for required parallel access, a very powerful parallel access scheme can be generated by the control logic 12. When computed jump or multiple condition branch occurs, all possible branch paths are stored on high speed memory banks which are already accessed by the control logic 12 or are stored on the transition buffer 3. Once the starting location of the new branch path is determined, the remainder of the program is accessed by the CPU 1 in a sequential manner from the high speed memory banks 8.

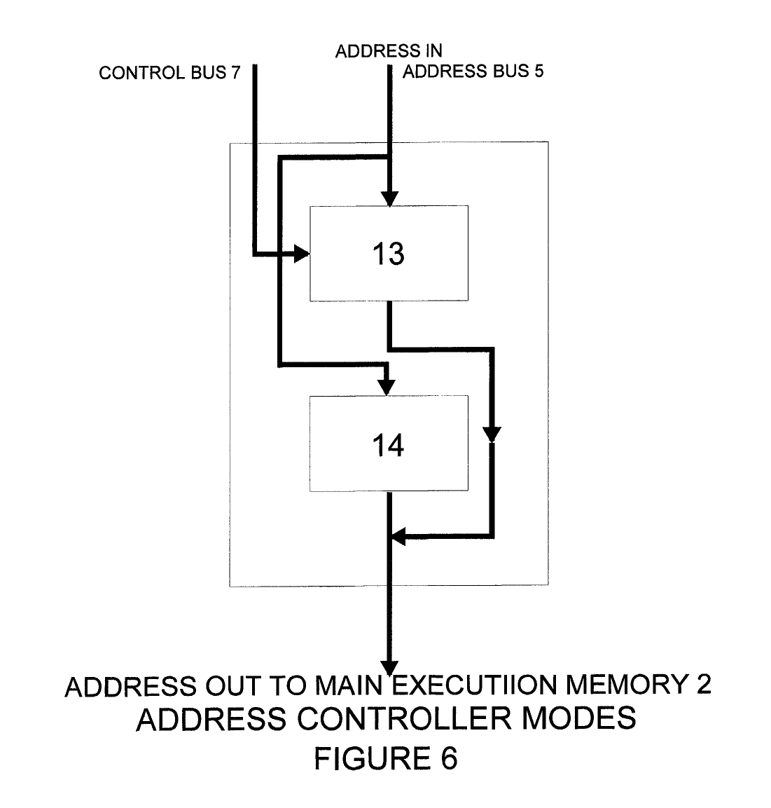

The address controller 4 is shown in FIG. 6. The address controller 4 is an important subsystem that generates the correct address for the necessary memory locations in high speed memory banks 8 located in the main execution memory 2. This is necessary when the CPU 1 changes the execution mode from the transition buffer 3 to the high speed memory banks 8.

As shown in FIG. 6 the address controller 4 comprises logic to facilitate the transfer of memory access from transition buffer 3 to main execution memory 2.

The address controller 4 can operate in different modes. It can directly take the address of the next high speed memory bank relating to a set of starting locations for a jump or branch location from the transition buffer 3. The control logic 13 will then translate and decode the address of the actual device on the main execution memory 2 and generate appropriate signals on the control bus 7 to enable the required high speed memory bank 8 on the main execution memory 2.

In other possible mode, the a set of starting locations relating to a jump or branch location from the transition buffer 3 will be fed to control logic 14 in a coded form. A translation table in control logic 14 will then translate and decode the address of the actual device on the main execution memory 2 and generate appropriate signals on the control bus 7 to enable the required high speed memory bank 8 on the main execution memory 2.

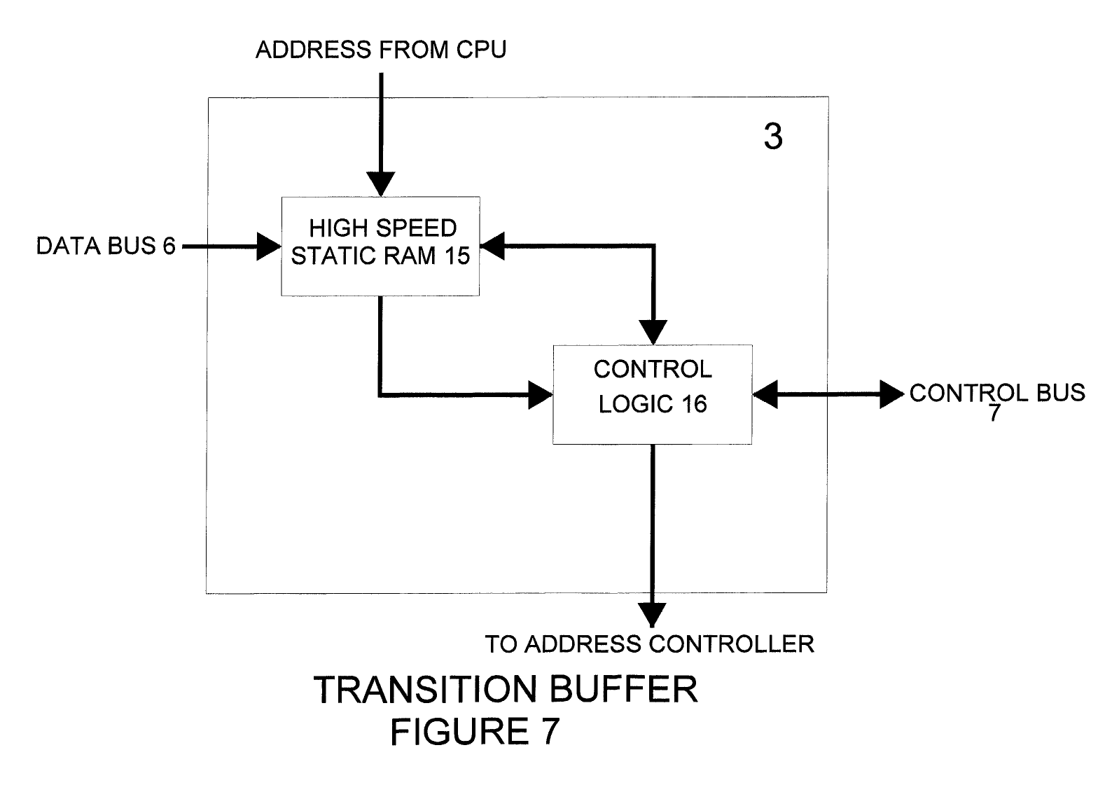

The transition buffer 3 is shown in FIG. 7. The CPU 1 will interface with the transition buffer 3 by the address bus 5, data bus 6 and the control bus 7. The transition buffer 3 will produce output to the address controller 4 and generate necessary control signal on control bus 7.

The transition buffer 3 comprises a high speed static RAM 15 which has access time comparable to the cycle time of the CPU 1. The transition buffer 3 comprising of high speed memory 15 contains the first starting memory locations for each jump and branch of the program. The number of locations depends upon the ratio of access time of the main execution memory 2 to the access time of the transition buffer high speed static RAM 15.

The transition buffer 3 also comprises a control logic 16 which translates the address of the next high speed memory bank relating to a set of starting locations for a jump or branch location from the transition buffer 3 in appropriate format for the address controller 4 to translate and decode the address of the actual device on the main execution memory 2 and generate appropriate signals on the control bus 7 to enable the required high speed memory bank 8 on the main execution memory 2. If desired, the transition buffer can be implemented with two level static RAMs with different speeds.

The present invention allows both pipelined and non pipelined architecture in the computer system. The present invention allows both pipelined and non pipelined architecture to execute program without interruption or any other execution delay. The primary goal is to execute program without interruption or any other delay normally associated with prior art computer systems. The implementation works with both RISC and CISC type architectures. The computer system will also be able to efficiently execute VLIW type architectures.

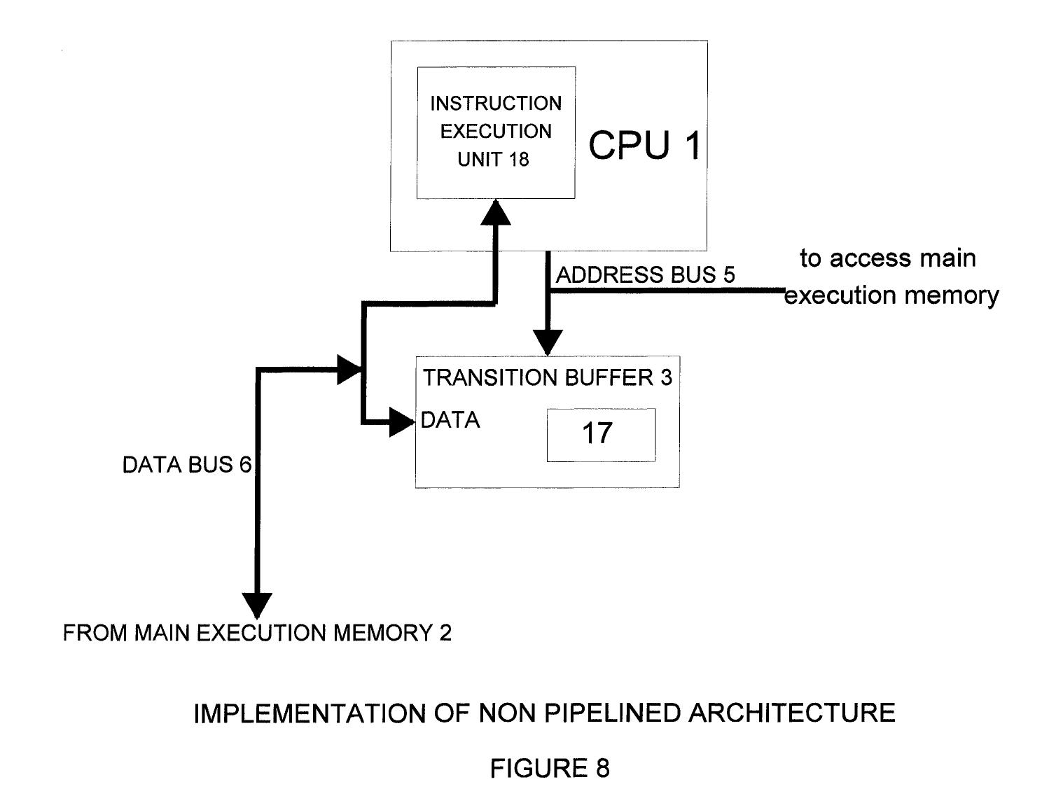

In non pipelined processors the execution after a branch or jump instruction continues by transferring program execution to the new branch path locations from the transition buffer 3. As shown in FIG. 8, in non pipelined processors there is no pipeline to be filled before the processor executes first instruction or a program branch occurs. Also, there is no interruption before the next instruction is executed. The instruction execution switches from the transition buffer 3 to the main execution memory 2 as required. The problem occurs when a memory reference is required. An important strength of the present invention is that it is possible to know in advance where the branch path would occur. Compile time is an appropriate process where the necessary information regarding required memory reference is resolved and used later in the actual loading and execution of the program with required memory reference.

In non pipelined processors the execution after a branch or jump instruction continues by transferring program execution to new branch path locations. In non pipelined processors there is no pipeline to be filled before the processor executes first instruction. There is no interruption before the next instruction is executed.

If the memory space on the data transition buffer is not sufficient for the program or data storage for random access, additional space can be created on the main data memory by connecting a large number of data memory locations on the main data memory in parallel and have data output already accessed and available for immediate read and use them as needed. This will make it possible to know, when and where a data will be required during a branch or jump instruction. It is also possible to employ unused portion of the instruction transition buffer or main instruction memory to achieve the same objective.

A separate pipeline of data which is required by the CPU 1 and which is not present in the appropriate transition buffer can be either created in the transition buffer 3 and stored in a separate area 17 in the transition buffer or can be stored in a separate high speed memory banks in the main execution memory 2 as explained earlier. This shows an additional strength of the present invention in terms of multiple options available for achieving the same design goals. The transition buffer 3 holds the most recently used data which will not require the CPU 1 to frequent access to the main execution memory or to the main data memory for the Harvard type architecture. However, if all the data is not available in the transition buffer, in the present invention it is possible to load the required data from the main execution memory to the appropriate transition buffer in a separate area 17 using a dedicated pipeline of data.

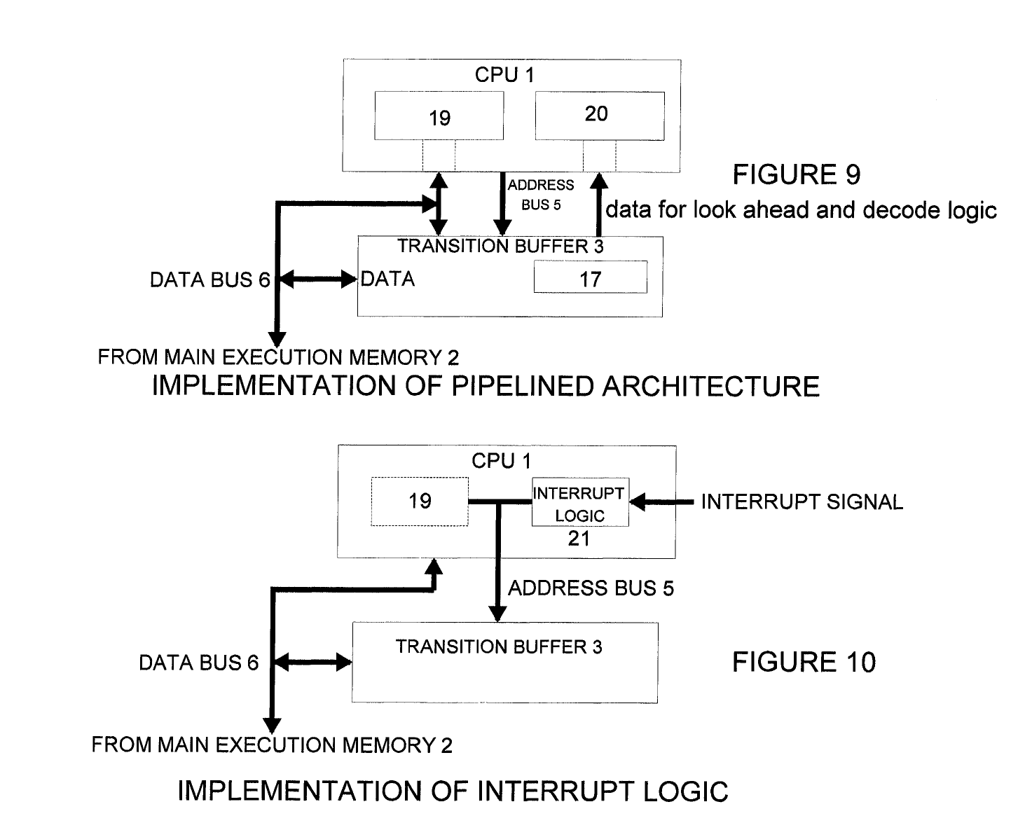

FIG. 9 shows a scheme to implement a pipelined architecture for the CPU 1. In a pipelined processors the program execution after a branch or jump instruction continues by transferring program execution to the new branch path locations. In a pipelined processors, there is an instruction pipeline to be filled before the processor executes first instruction after a branch or jump instruction. There is inherent delay that exists in pipelined processors. Different techniques such as branch prediction logic and delay slot registers are used to reduce this delay. This techniques are well understood and successfully used in the prior art. Without any additional logic or other scheme used in the prior art, the inherent delay would be unavoidable. The same techniques which are used in the prior art can be used in the present invention to avoid delays after and branch or jump instruction. However, the present invention offers more advanced techniques to virtually eliminate delays after a branch or jump instruction.

The present inventor has developed an additional technique called “look ahead and decode logic”. This technique substantially reduces or eliminates inherent delays after a program branch occurs.

As the silicon process technology advances, the cost of silicon hardware is reduced dramatically. Also, higher gate densities are realized at lesser power consumption on the same silicon die size. Because of this reason, the implementation of novel and efficient logic for superior processor speed and performance takes priority over mere reduction in raw gate count on the silicon or reduction in silicon die size.

The branch look ahead and decode logic 20 is shown in FIG. 9. This comprises of one or more instruction pipeline logic as applied to processors in the present invention. These pipeline logic blocks in look ahead and decode logic 20 operates in parallel and decodes instructions located on different branch and jump paths in advance before the actual program execution occurs. In the present invention, branch or jump program locations are located on different parallel memory banks. It is possible to predict the sequential order in which the jumps and branches will occur in normal program execution.

As described earlier, the transition buffer 3, contains first starting memory locations for each jump and branch of the program. This information can be used to create a pipeline of all the branch and jump instructions to be executed by the CPU 1 without significant delay. Every time a branch or jump occurs, the available information from the transition buffer 3 will be used to start decoding the instruction in advance by creating a pipeline from the information available from the transition buffer 3.

A separate sequential pipeline containing all the branch and jump starting locations can be either created in the transition buffer 3 or the main execution memory 2. As the program starts execution, the branch locations will be available to the look ahead and decode logic 20. The multiple pipelines to implement look ahead and decode logic will decode more than one branch paths in advance. When the actual branch location to be executed is loaded in the program counter of the CPU 1, the CPU 1 will use already decoded instruction pipeline present in the look ahead and decode logic 20.

The CPU will use as much decoded instruction stream in the branch path as the look ahead and decode logic 20 pipeline will permit. There may be some dependencies present at the time CPU 1 starts executing the branch path from the fully or partly decoded instruction stream in look ahead and decode logic 20. If the instruction stream in the look ahead and decode logic 20 requires data from the current instructions being executed, the look ahead and decode logic will be waiting for this data and complete the execution of instruction stream in the pipeline after the required data is available without program interruption.

The transition buffer holds the most recently used data which will not require the CPU 1 to frequent access to the main execution memory or to the main data memory for the Harvard type architecture, If the memory space on the data transition buffer is not sufficient for the data storage for random access, additional space can be created on the main data memory by connecting a large number of data memory locations on the main data memory in parallel and have data output already accessed and available for immediate read and use them as necessary. It is also possible to employ unused portion of the instruction transition buffer or main instruction memory.

This will allow when and where a data will be required during a branch or jump instruction. A separate pipeline of data which is required by the CPU 1 and which is not present in the appropriate transition buffer can be either created in the transition buffer 3 and stored in a separate area 17 in the transition buffer as shown in FIG. 9. The data for memory reference can also be stored in a separate high speed memory banks in the main execution memory 2 as explained earlier. This shows an additional strength of the present invention in terms of multiple options available for achieving the same design goals. However, if all the data is not available in the transition buffer, in the present invention it is possible to load the required data from the main execution memory to the appropriate transition buffer in a separate area 17 using a dedicated pipeline.

The present invention also offers zero latency interrupt response. By providing interrupt service routines on the transition buffer, the interrupt service can be performed without any latency. If the service routines are much larger in size, the starting locations can be located on the transition buffer 3 and the remainder of the routine on the main execution memory 2. This will still allow zero latency interrupt response. FIG. 10 shows how the interrupt logic can be implemented. The interrupt signal is received by the interrupt logic 21 and translated to a specific routine without any delay since the routine is located on high speed transition buffer 3 which does not require long delay to respond.

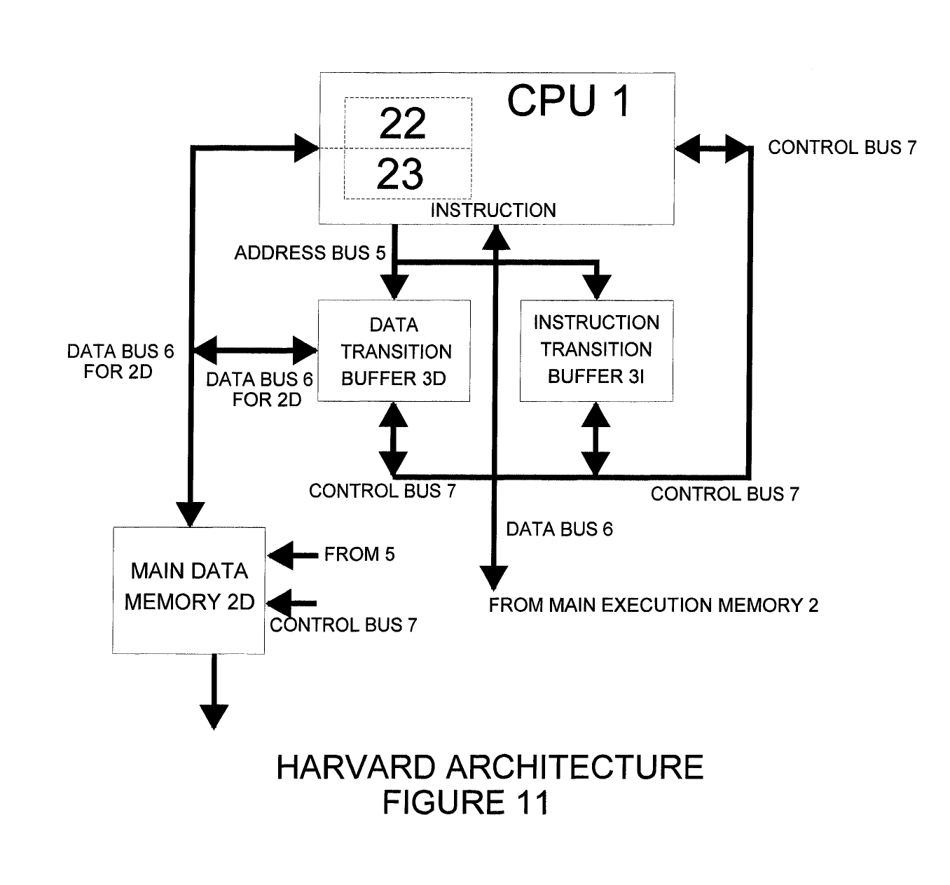

The computer system based on the present invention can be also implemented in Harvard type architecture. The data and instruction memory can be resident on different memory areas as shown in FIG. 11. The transition buffer will be divided in functional elements, data transition buffer 3D and instruction transition buffer 3I.

The instruction transition buffer 3I will act like normal interaction transition buffer described earlier.

The data transition buffer 3D will be provided with an associated main data memory 2D if required. The main data memory 2D will contain the remainder of data associated with each set of starting locations for a given data segment. For a contiguous block or segment of data, the data transition buffer 3D will house the starting locations of data, which will be fetched at the CPU 1 cycle time. The data read register 22 should be able to store multiple data words from the CPU 1 or the input/output device or main data memory 2D. As described earlier, while the address controller will access the main data memory 2D, the CPU 1 will process data by reading starting locations for a given data block from the data transition buffer 3D. While the data from the data transition buffer 3D is being accessed, the address controller will prepare the main data memory 2D to read data from the main data memory 2D. At the end of the last read cycle from the data transition buffer 3D, a multiple number of data locations are stored in a data read register 22 from at least two parallel banks of data memory 2D. The data stored in the data read register 22 is then read and processed by the CPU 1 at CPU 1 cycle time from alternate data memory banks on 2D. While one parallel data bank on 2D is read by the CPU 1, the next data bank is accessed for the next set of data locations from the main data memory 2D.

In the data write mode data can be written either from the CPU 1 or from input/output controller. The data write is performed using the data transition buffer 3D or data write register 23.

The data arriving in a continuous stream at the CPU 1 cycle time is stored in the data transition buffer 3D in series. The access time of the transition buffer is identical to the CPU 1 or the input/output device. The data written in transition buffer 3 can be used for starting locations of future read operation. The remainder of the data then can be written in the main data memory 2D to complete a valid block of data. The data therefore can be written in series or sequential manner to the transition buffer 3 without any problem. The data write register 23 also has high access time and the data can be written at desired location at the same speed that it arrives. The data write register 23 should be able to store multiple data words from the CPU 1 or the input/output device. The data write register 23 then stores the data from the arriving data stream. This can be done in series or parallel. The access time of the main data memory 2D is much slower. For the data write register 23 to write to the main data memory 2D, the transfer has to occur in parallel paths. The data from the data write register 23 to the main data memory 2D can be done in different possible parallel modes. The parallel data banks on main data memory 2D can be enabled for write operation in advance. The transfer can then occur in parallel blocks of data. The data then can be enabled and written in alternate parallel banks on the main data memory 2D. This is done in parallel mode. The size of the data write register 23 will depend upon the size of the data bus and the access time of the main data memory 2D. The data is stored in the main data memory 2D in parallel to be used in future read cycle. It is also possible to bypass the data transition buffer 3D and store the incoming data directly in the data write register 23. The data from the data write register 23 is then written to the main data memory 2D as described earlier.

It should be noted and understood that both the data read register 22 and data write register 23 are only an intermediate location for data to transfer between the main data memory and the CPU 1 or the input/output device. No change in the value of data will be permitted at these registers. The logic to detect multiple write sources to the same location will also monitor these registers.

In state of the art high performance computers, the data processed by the CPU 1 is generally a contiguous block of multiple pieces of data. This data can be used in read or write mode as described earlier.

However, it is also necessary in some applications to randomly access single pieces of data at CPU 1 cycle time. This is achieved by storing the data to be randomly accessed in only data transition buffer 3D. All the data stored in data transition buffer 3D, can be accessed by the CPU 1, at the CPU 1 cycle time.

An important feature of the present invention is the ability of the main data memory 2D and main execution memory 2 to accomplish connection of parallel memory banks in a series and or parallel configuration as needed. A flexible connection scheme will allow the main data memory 2D and instruction memory 2 to be connected in a desired configuration to allow individual memory elements to be accessed randomly when needed.

Another advantage of the present architecture is that the problems relating to cache coherency and consistencies are eliminated. Only one copy of data is maintained either in the transition buffer or the main execution memory. There are no multiple copies of the same data to cause any conflict between data values in different memory areas. There is also no conflict between the data present in the transition buffer or the main execution memory with the data obtained from any input/output device. This greatly simplifies the architecture and design of the system and improves performance.

It should be observed and noted that the present architecture offers operation and execution that is deterministic and predictable. Many of the problems with timing conflicts can be determined at the compile time. Precaution can be taken at the compile time to determine the timing of writing of data to a specific location by different devices. This information can then be used to assure that proper sequence of machine language code is used to avoid any conflict between different devices.

In the preceding description, the different building blocks of the computer system is shown separately. However, they can be combined appropriately to make the system more compact, such as incorporating the transition buffer in the CPU for certain applications.

The transition buffer 3 may not always be large enough for certain applications, in such cases the main execution memory 2 will hold addresses of some starting locations and transfer them to the transition buffer as needed.

The present invention offers great increase in speed by use of transition buffer. In prior art systems when a larger and new program segments needs to be loaded in the cache, a considerable time is used in transferring the program to the cache. This time is saved in the present invention by allowing a large program segment to be processed by the CPU without any delay.

Operation of the Computer System

The operation of the computer system based on the present invention will now be described as shown in FIG. 1. The computer is started by reset. After initial reset conditions are satisfied, at the initial start of the program, memory locations on the first high speed memory bank 8 is executed by the CPU 1 in sequential order. When a jump or branch instruction is encountered, the starting locations of the new jump or branch is executed from the transition buffer 3. This is done by CPU 1 by selecting the address of the memory location on the transition buffer 3. The program counter on the CPU 1 is loaded with the address of the locations from the transition buffer 3. While the CPU 1 is executing starting locations of the new jump or branch, the main execution memory 2 is being accessed by the address controller 4. The address controller 4 communicates with transition buffer 3, through a logic in the address controller 4 which relates each group of starting locations on the transition buffer 3 with a group of memory locations on the main execution memory 2 where the remainder of the program is located. The address controller 4 begins access to the main execution memory 2 at the same time the CPU 1 starts executing the first memory location of the new branch program locations from the transition buffer 3. The slower main execution memory 2 takes multiple CPU 1 cycles to complete the access. The number of starting locations on the transition buffer 3 is generally equal to the multiple CPU 1 cycles needed to access main execution memory 2.

When the first of the starting memory locations is executed by the CPU 1 from the transition buffer 3, after a jump or a branch instruction, the address controller 4 simultaneously fetches the address of the high speed memory bank 8 and the first location on the high speed memory bank 8. This is the first location the CPU 1 will execute when it switches from the transition buffer 3 to the high speed memory bank 8. As the first location on the transition buffer 3 will begins execution, the address controller will decode the address of the required high speed memory bank 8 and the high speed memory bank 8 will begin access to the accessed memory cells 9 in the high speed memory bank 8. After the required access time to the high speed memory bank 8 is completed, the memory cells 9 of the high speed memory bank will produce output at the accessed locations. These outputs will be available to the memory mux 11. The CPU 1 will be able to execute these instructions at the CPU 1 cycle time. The transition buffer 3 will have provided enough time for the high speed memory banks 8 to access the memory cells 9 and output will be available to the memory mux 11. At this stage, the CPU 1 will stop fetching the program data from the transition buffer 3 and will switch to high speed memory banks 8. This will continue until the program is completed or next jump or branch instruction is encountered.

The CPU 1 according to the principles of the present invention executes the branch instructions efficiently due to the manner in which the main execution memory 2 is organized to allow proper access to the remainder of the program after first fetching instruction or data from the transition buffer 3.

In an unconditional branch or direct jump instructions, the program contents after the branch can be located on any parallel high speed memory bank 8. When the CPU 1 starts executing the starting instructions from the transition buffer 3, the address controller 4 will access the required remainder of the program on the main execution memory 2 by switching over to the main execution memory 2.

In a subroutine call, the program contents after the branch can be located on any parallel high speed memory bank 8. When the CPU starts executing the starting instructions from the transition buffer 3, the address controller 4 will access the required remainder of the program on the main execution memory 2 by switching over to the main execution memory 2.

In a conditional branch, the program contents after all possible branch conditions will be located on different parallel high speed memory banks 8. The number of parallel high speed memory banks 8 required will be equal to the number of conditions the program branch can be diverted to. When the CPU 1 starts executing the starting instructions from the transition buffer 3, the address controller 4 will access the required number of parallel high speed memory banks 8 on which the remainder of different branch programs are located. After the condition is evaluated and the branch has been determined, the CPU 1 program counter will then be loaded with the location of the selected branch location determined by the condition evaluated by the CPU 1. The remainder of the program on the main execution memory 2 will be then be executed.

In a computed branch condition, the number of possible branches the program can transfer to is much larger in number. The program locations to be implemented after all possible computed branch conditions will be located on different parallel high speed memory banks 8. The number of parallel high speed memory banks required will be equal to the number of conditions the branch can be diverted to. When the CPU 1 starts executing the starting instructions from the transition buffer 3, the address controller 4 will access the required number of parallel high speed memory banks 8 on which the remainder of different branch programs are located. After the condition is evaluated and the branch has been determined, the CPU 1 program counter will then be loaded with the location of the selected branch location determined by the condition evaluated by the CPU 1. In this type of branch a large number of parallel high speed memory banks 8 will be needed. This is implemented by flexible connection scheme where a large number of parallel high speed memory banks 8 can be connected in different series or parallel connections. The flexible connection scheme has been described earlier.

In non pipelined processors, the execution after a branch or jump instruction continues by transferring program execution to new branch path locations. In non pipelined processors there is no pipeline to be filled before the processor executes first instruction. There is no interruption before the next instruction is executed.

In a pipelined processors, the program execution after a branch or jump instruction continues by transferring program execution to the new branch path locations. In a pipelined processors, there is an instruction pipeline to be filled before the processor executes first instruction after a branch or jump instruction. The branch look ahead and decode logic 20 described in FIG. 9 consists of one or more instruction pipeline logic used to cerate instruction pipeline. These pipeline logic blocks operates in parallel and decodes instructions located on different branch and jump paths in advance before the actual program execution occurs. In the present invention, branch or jump program locations are located on different parallel memory banks 8. It is possible to predict the sequential order in which the jumps and branches will occur in normal program execution.

A separate sequential pipeline containing all the branch and jump starting locations can be either created in the transition buffer 3 or the main execution memory 2. As the program starts execution, the branch locations will be available to the look ahead and decode logic 20. The multiple pipeline logic to implement look ahead and decode logic 20 will decode more than one branch paths in advance. When the actual branch location to be executed is loaded in the program counter of the CPU 1, the CPU 1 will use decoded instruction present in the pipeline to continue execution. As explained earlier, this instruction has already been decoded in advance in the look ahead and decode logic 20.

The CPU 1 will use as much decoded instruction stream in the branch path as the look ahead and decode logic 20 pipeline will permit. There may be some dependencies present at the time CPU 1 starts executing the branch path from the fully or partly decoded instruction stream. If the instruction stream in the look ahead and decode logic 20 requires data from the current instructions being executed, the look ahead and decode logic 20 will be waiting for this data and complete the execution of instruction stream in the pipeline without any delay after the required data is available.

The present invention also offers zero latency interrupt response. By providing interrupt service routines on the transition buffers, the interrupt service can be performed without any latency. When an interrupt is generated by an external event, the interrupt logic 21 will activate the required service routines.

The computer system based on the present invention can be also implemented in Harvard type architecture. The data and instruction memory 2D and 2 can be resident on different memory areas. The transition buffer will be divided in data transition buffer and instruction transition buffer 3D and 3I.

Separate section of the data bus 6 will carry only data from the main data memory 2D to the CPU and the data transition buffer 3D as shown in FIG. 11. Data bus 6 will be different for Harvard architecture than it is for standard architecture described earlier in FIG. 1. The data bus will carry separate data and instruction content on separate data lines to increase the data flow in parallel format. Data bus 6 will also carry instruction content from the main execution memory to CPU 1 and the instruction transition buffer 31.

As described earlier, while the address controller will access the main data memory, the CPU 1 will process data by reading starting locations for a given data block from the data transition buffer 3D. While the data from the data transition buffer 3D is being accessed, the address controller will prepare the main data memory 2D for data read from the main data memory 2D. At the end of last read cycle from the data transition buffer 3D, a multiple number of data locations are stored in a data read register 22 from at least two parallel banks of high speed data memory. The data stored in the data read register 22 is then read and processed by the CPU 1 at CPU 1 cycle time from alternate data memory banks. While one parallel data bank is read by the CPU 1, the next data bank is accessed for the next set of data locations from the main data memory 2D.

In the data write mode data can be written either from the CPU 1 or from input/output controller. The data write is performed using the data transition buffer 3D or data write register 23.

The data arriving in a continuous stream at the CPU 1 cycle time is stored in the data transition buffer 3D in series. The access time of the position buffer is identical to the CPU 1 or the input/output device. The data written in transition buffer 3 can be used for starting locations of future read operation. The remainder of the data then can be written in the main data memory 2D to complete a valid block of data The data therefore can be written in series or sequential manner to the transition buffer 3 without any problem. The data write register 23 also has high access time and the data can be written at desired location at the same speed that it arrives. The data write register 23 should be able to store multiple data words from the CPU 1 or the input/output device. The data write register 23 then stores the data from the arriving data stream. This can be done in series or parallel. The access time of the main data memory 2D is much slower. For the data write register 23 to write to the main data memory 2D, the transfer has to occur in parallel paths. The data from the data write register 23 to the main data memory 2D can be done in different possible parallel modes. The parallel data banks on main data memory 2D can be enabled for write operation in advance. The transfer can then occur in parallel blocks of data. The data then can be enabled and written in alternate parallel banks on the main data memory 2D. This is done in parallel mode. The size of the data write register 23 will depend upon the size of the data bus and the access time of the main data memory 2D. The data is stored in the main data memory 2D in parallel to be used in future read cycle. It is also possible to bypass the data transition buffer 3D and store the incoming data directly in the data write register 23. The data from the data write register 23 is then written to the main data memory 2D as described earlier.

It should be noted and understood that both the data read register 22 and data write register 23 are only an intermediate location for data to transfer between the main data memory and the CPU 1 or the input/output device. No change in the value of data will be permitted at these registers. The logic to detect multiple write sources to the same location will also monitor these registers.

In state of the art high performance computers, the data processed by the CPU 1 is generally a contiguous block of multiple pieces of data This data can be used in read or write mode as described earlier.

However, it is also necessary in some applications to randomly access single pieces of data at CPU 1 cycle time. This is achieved by storing the data to be randomly accessed in only data transition buffer 3D. All the data stored in data transition buffer can be accessed by the CPU at the CPU 1 cycle time.

Power Management

Power management is an important consideration in the design of any modem computer system. Power usage and efficiency has an important environmental and cost impact. The present invention offers a great environmental benefit by providing a unique and novel power management technique. Prior art computer system generally uses a separate IC to manage power and reduce related losses. This method requires a separate IC which also uses some power, which adds to the cost and in addition produces lesser power savings for the overall system. In prior art systems the power management is achieved by turning off the part of the system that is not operating. This is not always easy to accomplish and involves frequent switching of various subsystems on the computer. It is also difficult to separate the whole system in to most efficient power blocks.

Power management in the present invention is accomplished by the of use of built in power management system. In the present invention, the power is selectively applied only to that part of the computer system which is being currently and actively used. All other parts of the system are either turned off or are in quiescent or standby mode consuming very little or no power.

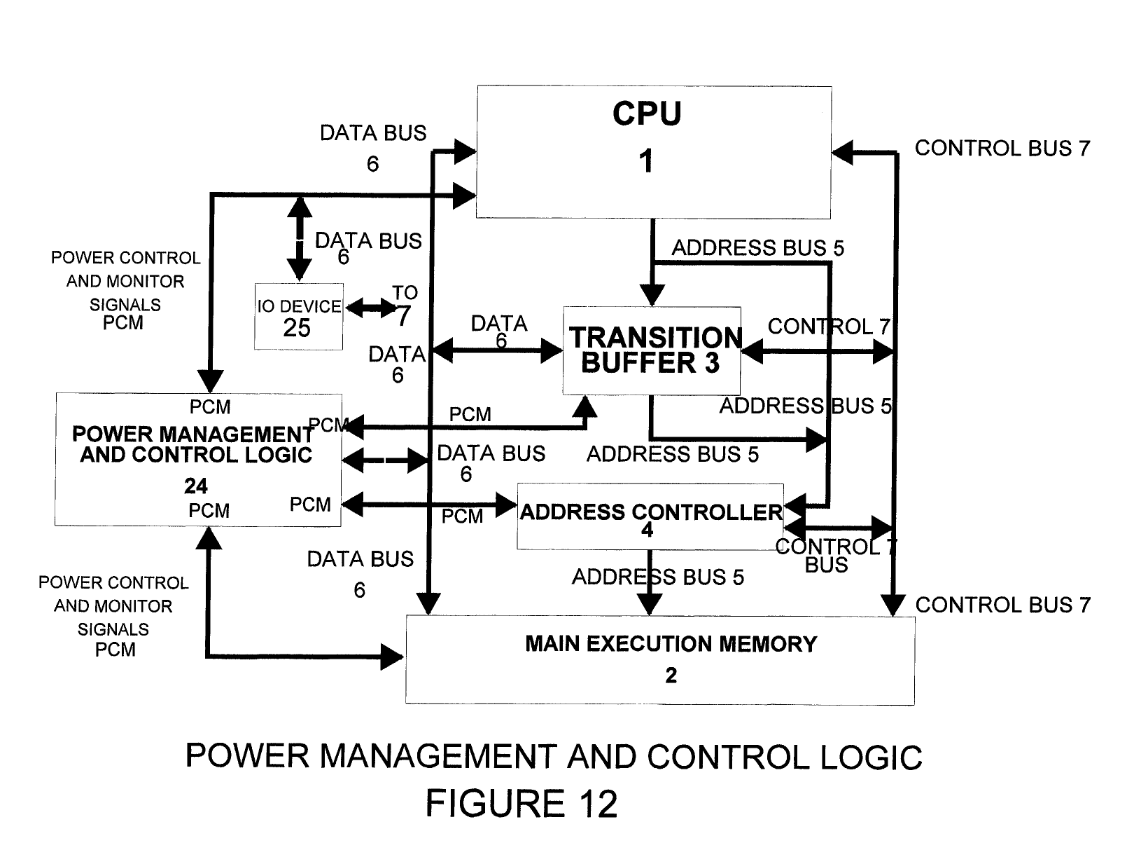

FIG. 12 illustrates the concept of power management as used in the present invention and shows the required control logic. The power management control logic 24, constantly monitors important subsystem blocks such as CPU 1, transition buffer 3, address controller 4, and the main execution memory 2. This is implemented by using power control and monitor signals PCM. After monitoring status of each subsystem, the control logic 24 turns on only that part of the subsystem that is currently active. And, as soon as the currently active subsystem completes the required task, the power to the active subsystem is turned off.

At the reset of the computer or when the computer CPU 1 is in quiescent or standby mode, power to the entire computer system is turned off except to the CPU 1 area where the program counter logic is located and in standby mode to the area where the last program instructions were located.

At the initial start, after the CPU 1 is entered in reset state, the power is turned on to the area where reset logic is located and then to the program counter area of the CPU 1. Power to the rest of the subsystems is turned off. The program counter allows the power management control logic 24 to decide what area of transition buffer 3 requires the power at the start. The transition buffer 3 data forces the power management control logic 24 to turn on power to the address controller 4 and applicable main execution memory 2 containing applicable parallel high speed memory banks 8. The power is maintained to the parallel high speed memory banks 8 until the program is completed or a program branch is encountered. After the program is completed the computer either goes in standby mode or reset mode as programmed.

If a program branch occurs, based on the program counter data, the power to the new starting locations for the new program branch on the transition buffer 3 is turned on. Power to the old parallel memory bank 8 is turned off. The address controller 4 is either put in standby mode or left turned on. The power managementcontrol logic 24 then turns the power on to the new parallel memory bank 8. The process then continues until the program is completed or a program branch is encountered. The power management process perpetually continues as described earlier for the program branch conditions. After the program is completed the computer either goes in standby mode or reset mode as programmed.

It is also important to remember that similar power management protocols can be tailored to meet the conditions on the computer input/outs and interrupt system.

High Speed DMA

High speed DMA is used to transfer program from mass storage devices like hard drives to the DRAM. This process can be performed at CPU 1 speed. As shown in FIG. 12, 10 device 25 is connected to the data bus 6 and control bus 7. Control signals are interfaced to the different building blocks by 25. For fast response data transfer, a block of data containing starting locations of jumps and branch instructions and sufficient program and instruction is transferred to the transition buffer and main execution memory at high speed. The CPU 1 starts executing the initial program while rest of the program is being loaded in the main execution memory 2. This is done in parallel at high speed. As the program continues to execute, rest of the program is loaded at high speed until the program is fully loaded in the DRAM.

Parallel Operation

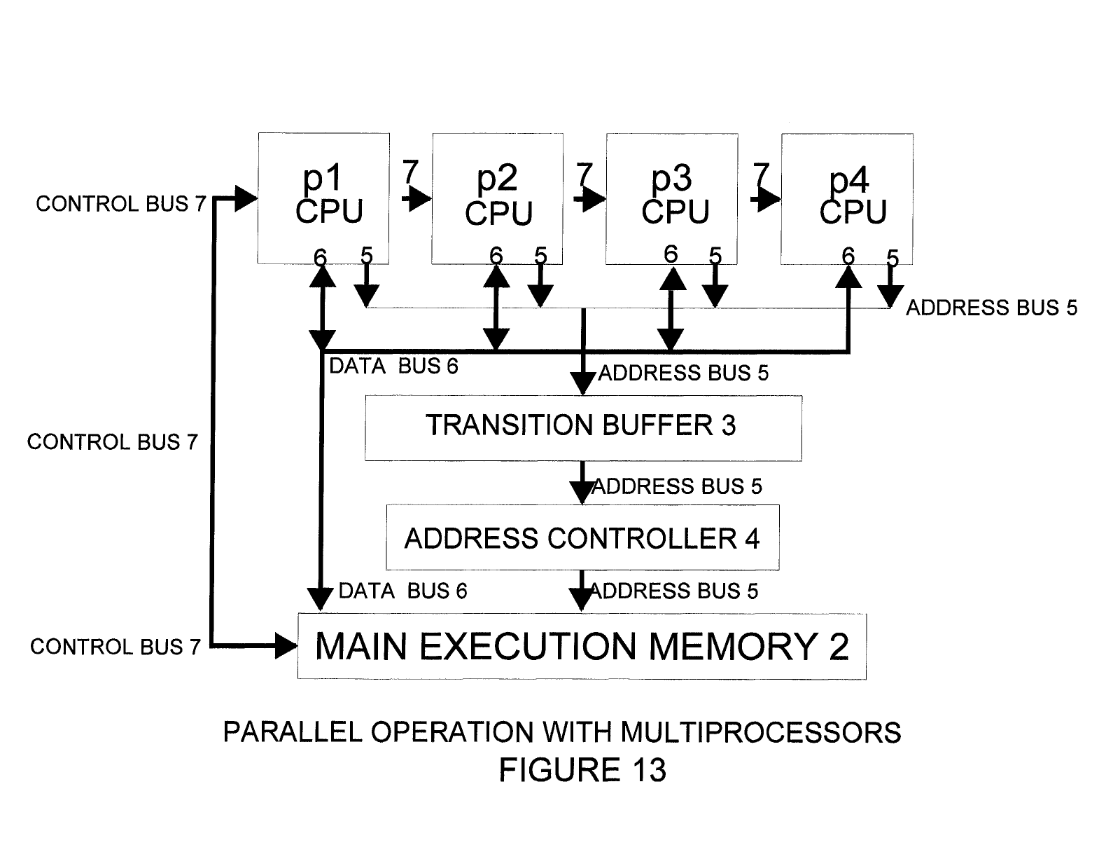

The present invention lends itself very effectively and efficiently suitable for parallel operation of multiple processors. FIG. 13 shows architecture to implement parallel processing multi processors to increase computation power for a single low cost memory computer system. The implementation uses single memory system to increase throughput and reduce system cost.

The memory in the present invention is organized as parallel units of high speed memory banks 8. The high speed memory banks 8 are connected in parallel to achieve continuous operation. A single or plurality of processors can operate on multiple units of high speed memory banks 8.

As shown in FIG. 13, a plurality of processors operate on memory system having parallel blocks of high speed memory banks 8. The memory system with parallel units of high speed memory banks naturally lends itself for parallel operation. The multiple processors can be organized in such a manner that one processor can operate on separate block of high speed memory bank 8. In this manner, a faster implementation of multi processor operation is achieved. Each processor operates and executes instructions from separate units of high speed memory bank 8. The total time to implement all the instructions are therefore reduced by the factor equal to the number of processors.

If there are dependencies present for any instruction which requires results from the previous or other instructions in the program, these instructions are maintained in the same block of high speed memory banks 8. A single selected processor will execute all the instructions with common dependencies. Compiler will resolve these dependencies at the compile time.

As shown in FIG. 13, consider 4 processors p1-p4 operating on Nmb high speed memory banks 8. The processor p1 will operate on first Nmb/4 parallel high speed memory banks 8. The processors p3 to p4 will each operate on successive Nmb/4 blocks of high speed memory banks 8. The data bus 6 can be used between the four processors in a required configuration with appropriate multiplexing scheme. This will limit the throughput in certain conditions. However, a wider data bus 6 with double or more number of bits will increase the throughput to a desired value. The compiler will examine related concurrences and dependencies at the compile time and will accordingly assign appropriate instructions to specific processors and high speed memory banks 8.

In multiprocessing computing environments, either with just a few processors or a massively parallel systems with hundreds of processors, it is critical that value of a data is maintained in the most recent state for any computing element to process. This architecture allows this to occur without any inconsistencies. Problems related to cache coherency and inconsistencies are eliminated. Unless it is necessary, only one location of data is maintained any where in the computing environment. Multiple copies of the same data are not allowed to exist. This can be implemented by choosing a location of the data either in the transition buffer of any unit or in a main execution memory of any unit.

Special control logic can be implemented in hardware to prevent simultaneous writing of same memory location by two or more processors. As shown in FIG. 13, the processors are connected in parallel. A control logic can be implemented within the CPU 1 or in other hardware which will monitor the location of any data being written and monitor to assure that only one write request is issued for any location, the second and following write requests to that location are disabled.

It should be observed and noted that the present architecture offers operation and execution that is deterministic and predictable. Many of the problems with timing conflicts can be determined at the compile time. In a multiprocessor systems, different processors are able to write to the same location or to different locations simultaneously. To prevent simultaneous writing by two processors at the same time to the same selected location, the compiler will generate sequential code that will prevent this from occurring in cases where it is possible. Precaution can be taken at the compile time to determine the timing of writing of data to a specific location by different devices. This information can then be further used to assure that proper sequence of machine language code is used to avoid any conflict between different processors of the multiprocessor computing system.

It is also possible to design architecture where multiple processors can operate with more than one memory system. Shared memory architectures without any cache coherency problems and massively parallel systems with deterministic characteristics and performance can be designed with the concept of the present invention. This will remarkably improve performance of the computing systems. It is possible to design many variations of the parallel processing architectures within the scope of the present invention.

The computer system based on the present invention is ideally suitable for applications like high speed internet servers used in server farm type applications. The parallel processor architecture of the present computer system will provide high bandwidth and flexibility required in intent applications.

Compiler Technology

The compiler and the assembler to be used for generating machine code for the present architecture will have to be designed specifically for the requirements of architecture based on the unique features of the present invention. Prior art compilers available in the Industry, are able to optimize code on the basis of cached systems. New compiler will have take into consideration the new architecture without the limitations of older cached systems. The compiler will have multiple capabilities to optimize the machine code on the basis of more flexible architecture. This will offer more options to generate optimized and efficient machine code. Many decisions regarding choice of memory locations where data and instruction segments will be located will be made more efficiently.

A major advantage of the new compiler would be to offer capabilities to predict possible timing and execution problems at the compile time.

It should be observed and noted that the present architecture offers operation and execution that is deterministic and predictable. Many of the problems associated with timing conflicts can be determined at the compile time. For uniprocessor systems precaution can be taken at the compile time to determine the timing of writing of data to a specific location by more than one device such as CPU and an input/output device. This information can then be used to assure that proper sequence of machine language code is used to avoid any conflict between different devices.

Just as it possible for the uniprocessor systems, it should be observed and noted that the present architecture also offers multiprocessor operation and execution that is deterministic and predictable. Many of the problems with timing conflicts can be determined at the compile time. In a multiprocessor systems, different processors are able to write to the same location or different locations simultaneously. To prevent simultaneous writing of two processors at the same time to the selected location, the compiler will generate sequential code that will prevent this from occurring in cases where it is possible. Precaution can be taken at the compile time to determine the timing of writing of data to a specific location by different devices. This information can then be further used to assure that proper sequence of machine language code is used to avoid any conflict between different processors of the multiprocessor computing system.

Fault Tolerance and Reliability of the System

Because of the inherent parallelism present in the architecture of the present invention, a high degree of fault tolerance is available from the system. If one area of memory system fails, the system will still continue to function allowing the faulty area to be isolated with proper protocols. Critical programs of the system can be located in redundant locations. If critical area fails in one area, the redundant area can continue the operation of the system. This allows self-healing attributes to be introduced in the system features. Special logic and protocol can be introduced in high reliability systems to detect any fault condition on the computing system and make correction accordingly.

The foregoing descriptions of specific embodiments of the present invention are presented for the purposes of illustration and description. They are not intended to be exhaustive or to limit the invention to the precise forms disclosed. Many modifications and variations are possible in view of the above teachings. The embodiments were chosen and described in order to best explain the principles and its practical applications, to thereby enable others skilled in the art to best utilize the invention and various embodiments with various modifications as are suited to the particular use contemplated. It is intended that the scope of the invention be defined by the following claims and their legal equivalents rather than the examples given.

What is claimed is:

1. A high speed, low power, cacheless computer system comprising:
at least one central processing unit (CPU) to execute instruction fetched by the central processing unit in response to the contents of the instruction selectively fetched from a computer system program;
a main execution memory means comprising a plurality of low cost low power high speed memory banks generally having a slower access time and serving as one of the areas to store said computer system program;
a transition buffer means comprising high speed memory which stores starting locations of program and data segments characterized by a branch or jump instructions and recently used memory references and data values;
an address controller means which includes a circuit to generate and create address for the main execution memory means to access remainder of the computer system program started and stored in said transition buffer means;
a first bus including an address bus able to transport and communicate address information;
a second bus including a data bus able to transport data information;
a third bus including a control bus able to transport and communicate control information; and
said central processing unit, main execution memory means, transition buffer means and address controller means are connected in such a manner that said first bus, second bus and third bus are able to transport and communicate address, data and control information between said central processing unit, main execution memory means, transition buffer means and address controller means; wherein
said central processing unit selectively couples with main execution memory means and executes instructions from the main execution memory means at the start of the program;
said central processing unit selectively couples with the transition buffer means and executes instructions from transition buffer means in such a manner that when a jump or branch instructions are encountered, the central processing unit fetches the starting memory locations of new program branch instruction from the said transition buffer means and continues to execute the instructions;
said central processing unit further couples with said address controller means and said main execution memory means while said central processing unit executes starting locations of a branch or jump location from said transition buffer means and allows enough time to elapse for the main execution memory to access memory locations located on said main execution memory means and place at the output of said main execution memory for the central processing unit to fetch;
said central processing unit then starts executing instructions from the main execution memory means until the central processing unit encounters program change characterized by completion of the program and a new program branch leading to the program locations on the transition buffer means.

2. A high speed, low power, cacheless computer system of claim 1 wherein the transition buffer means is made of static random access memory and said main execution memory means is made of dynamic random access memory.

3. A high speed, low power, cacheless computer system of claim 1 wherein said main execution memory means is made of dynamic random access memory and includes a plurality of groups of parallel memory cells wherein, a group of parallel memory cell is providing program instructions to central processing unit while other group is accessing memory cells for the next group of program instructions.

4. A high speed, low power, cacheless computer system of claim 1 wherein said central processing unit includes a logic which allow a group of recently used data to be stored in an area of said of a transition buffer means.

5. A high speed, low power, cacheless computer system of claim 1 wherein said central processing unit includes a logic for implementing non pipelined architecture whereby no instruction queue is provided in the central processing unit and includes a memory area which allow a group of recently used data to be stored in a separate area of said transition buffer means.

6. A high speed, low power, cacheless computer system of claim 1 wherein said central processing unit includes a logic for implementing a pipelined architecture for implementing program branch instructions whereby at least one instruction queue is provided for implementing program branch instructions in pipeline mode in locations characterized by the central processing unit and transition buffer means and main execution memory means and further includes a memory area which allows a group of recently used data to be stored in a separate area of said transition buffer means.

7. A high speed, low power, cacheless computer system of claim 1 wherein said central processing unit includes a logic for implementing a pipelined memory storage in main execution memory means wherein sequential starting locations of multiple branch instructions are stored for implementing program branch instructions as they occur in program execution in required order and determined at the compile time, whereby the starting locations for a new branch will be available to said central processing unit from this pipelined storage architecture.

8. Said pipelined memory storage as claimed in claim 7 has capability to locate in multiple areas characterized by said transition buffer or said main execution memory.

9. A high speed, low power, cacheless computer system of claim 1 wherein said central processing unit (CPU) includes a logic to prevent simultaneous writing of same location by more than one device.

10. A high speed, low power, cacheless computer system of claim 1 wherein said central processing unit (CPU) includes a logic to decode at least one block of a sequence of instruction in advance and make it available for execution when required.

11. A high speed, low power, cacheless computer system of claim 1 wherein said central processing unit (CPU) includes a logic and storage area to store data that can be available to central processing unit (CPU) at any time and can be related to main execution memory.

12. A high speed, low power, cacheless computer system of claim 1 wherein said central processing unit(CPU) includes a logic and storage area to store data that can be selectively loaded from the main execution memory to the storage area and selectively removed from the storage area to be determined by the execution requirement of the program and conditions determined at the compile time.

13. A high speed, low power, cacheless computer system of claim 1 wherein said central processing unit(CPU ) includes a look ahead and decode logic which comprises plurality of logic blocks to decode branch instructions in advance by determining the sequence of branch and jump instructions from the previously stored branch and jump instructions storage area and sequential order determined at the compile time and decode them in advance permitted by program execution conditions, said instruction storage area is located in said main execution memory means or transition buffer means.

14. A high speed, low power, cacheless computer system of claim 1 which includes a Direct access memory means, which further includes logic to transfer data from external device characterized by a hard drive, said logic allows a small block of data and instructions to be loaded in said transition buffer means and said main execution memory means to start execution of instructions immediately and load remainder of data and instructions as the program starts executing thereby providing fast response direct memory access to said computer system.

15. A high speed, low power, cacheless computer system of claim 1 wherein said central processing unit comprises a logic to implement zero latency interrupt response system that activates interrupt service routine without any delay involved in accessing the main execution memory means by using transition buffer means to start the interrupt service routine.

16. A high speed, low power, cacheless computer system of claim 1 wherein a power management and control logic optimizes power consumption by turning on only the active areas of the system and turning off the remainder of the system components.

17. A high speed, low power, cacheless computer system able to implement Harvard type architecture comprising:
at least one central processing unit (CPU) to execute instruction fetched by the CPU in response to the contents of the instruction and data,
a main execution memory means comprising a plurality of low cost low power high speed memory banks to store instruction program contents for central processing unit (CPU) to execute instructions and selected data segments for data storage in separate areas and generally having a slower access time;
a main data memory means comprising a plurality of low cost low power high speed memory banks to store data segments for data storage in separate areas and generally having a slower access time;
a transition buffer means comprising high speed memory which stores starting locations for program branch instructions and data segments for data storage in separate memory areas and recently used memory references in selected areas;
an address controller means which includes a means to generate and create address for the main execution memory means for instruction and main data memory for data to facilitate the access to remainder of the instruction and data segments started and stored in the said transition buffer means;
a first bus including an address bus able to transport and communicate address information;
a second bus including a data bus able to transport data information;
a third bus including a control bus able to transport and communicate control information; and
said central processing unit, main execution memory means, transition buffer means and address controller means are connected in such a manner that said first bus, second bus and third bus are able to transport and communicate address, data and control information between said central processing unit, main execution memory means, transition buffer means and address controller means; wherein
said central processing unit selectively couples with main execution memory means and executes instructions from the main execution memory means at the start of the program;
said central processing unit selectively couples with the transition buffer means and executes instructions from transition buffer means in such a manner that when a jump or branch instructions are encountered, the central processing unit fetches the starting memory locations of new program branch instruction from the said transition buffer means and continues to execute the instructions;
said central processing unit further couples with said address controller means and said main execution memory means while said central processing unit executes starting locations of a branch or jump location from said transition buffer means and allows enough time to elapse for the main execution memory means to access memory locations located on said main execution memory means and place at the output of said main execution memory for the central processing unit to fetch;
said central processing unit selectively couples with the transition buffer means and extracts data from the main data memory means and transition buffer means in such a manner that when a data element is needed, the central processing unit fetches the starting memory locations of new data from the said transition buffer means and allows enough time to elapse for the main data memory means to access data locations and place at the output for the central processing unit to fetch, said central processing unit then starts extracting data from the main data memory means until the central processing unit encounters request for new data,
said central processing unit selectively couples with the transition buffer means and writes data to the main data memory means and transition buffer means in such a manner that when a data element is written, the central processing unit writes starting memory locations of new data to the said transition buffer means and allows enough time to elapse for the main data memory means to access data locations and enable the main data memory means for central processing unit to write, said central processing unit then starts writing data to the main data memory means until the central processing unit encounters request for new data to be written.
said central processing unit then starts executing instructions from the main execution memory means until the central processing unit encounters program change characterized by completion of the program and a new program branch leading to the program locations on the transition buffer means.

18. A high speed, low power, cacheless computer system of claim 17 wherein said central processing unit (CPU) includes a logic and storage area to store data that can be available to central processing unit (CPU) at any time and can be related to main data memory said central processing unit (CPU) further includes a logic to prevent simultaneous writing of same location by more than one device.

19. A high speed, low power, cacheless computer system comprising:
plurality of central processing units (CPU) to execute instruction fetched by each of the central processing unit in response to the contents of the instruction selectively fetched from a computer system program;
a main execution memory means comprising a plurality of low cost low power high speed memory bank generally having a slower access time and serving as one of the areas to store said computer system program;
a transition buffer means comprising high speed memory which stores starting locations of program and data segments characterized by a branch or jump instruction s and recently used memory references and data values;
an address controller means which includes a circuit to generate and create address for the main execution memory means to access remainder of the computer system program started and stored in said transition buffer means;
a first bus including an address bus able to transport and communicate address information;
a second bus including a data bus able to transport data information;
a third bus including a control bus able to transport and communicate control information; and
said central processing unit, main execution memory means, transition buffer means and address controller means are connected in such a manner that said first bus, second bus and third bus are able to transport and communicate address, data and control information between said central processing unit, main execution memory means, transition buffer means and address controller means; wherein
at least one central processing unit selectively couples with main execution memory means and executes instructions from the main execution memory means at the start of the program;
at least one central processing unit selectively couples with the transition buffer means and executes instructions from transition buffer means in such a manner that when a jump or branch instructions are encountered, the central processing unit fetches the starting memory locations of new program branch instruction from the said transition buffer means and continues to execute the instructions;
said at least one central processing unit further couples with said address controller means and said main execution memory means while said central processing unit executes starting locations of a branch or jump location from said transition buffer means and allows enough time to elapse for the main execution memory to access memory locations located on said main execution memory means and place at the output of said main execution memory for the central processing unit to fetch;
said central processing unit then starts executing instructions from the main execution memory means until the central processing unit encounters program change characterized by completion of the program and a new program branch leading to the program locations on the transition buffer means.

20. A high speed, low power, cacheless computer system of claim 19 wherein said central processing unit (CPU) includes a logic to prevent simultaneous writing of same location by more than one device.
